(19) United States
(12) Patent Application Publication
(10) Pub. No.: US 2016/0162847 A1
(43) Pub. Date: Jun. 9, 2016

(54) TIME-BASED ACTIVITY LIST MANAGEMENT

(71) Applicant: International Business Machines Corporation, Armonk, NY (US)

(72) Inventors: Paul Bastide, Boxford, MA (US); Bernadette A. Carter, Raleigh, NC (US)

(21) Appl. No.: 14/564,461

(22) Filed: Dec. 9, 2014

(51) Int. Cl. G06Q 10/10; H04L 12/58; G06Q 50/00

(52) U.S. Cl. CPC G06Q 10/1097; G06Q 50/01; H04L 51/32

(57) ABSTRACT

Embodiments of the invention provide a method, system and computer program product for time based activity list management. In an embodiment of the invention, a method for time based activity list management includes receiving a multiplicity of events in memory of a host computing system from over a computer communications network for display in an activity stream of an end user of an enterprise application executing in the memory of the host computing system. The method additionally includes selecting a subset of the events according to an action required to by performed by the end user by each of the events in the subset and prioritizing ones of the events with corresponding actions determined to require a greater period of time to complete. Finally, the method includes displaying the events in the activity stream in an order of priority determined for the events.

### BACKGROUND OF THE INVENTION

1. Field of the Invention

The present invention relates to activity stream management and more particularly to prioritization of activity events in an activity stream.

2. Description of the Related Art

An activity stream is a list of recent events determined to be relevant to a particular end user or class of end user as presented in a network enabled application and in particular, a Web site. The notion of an activity stream first presented itself in the context of social networking. In the context of social networking, an activity stream provided updates as to events occurring in respect to one's contacts or “friends” within a social network. Examples include the latest postings by different contacts of the end user, or different postings referencing different contacts of the end user.

While the activity stream finds its origins in the space of social networking, the activity stream more recently has become an important element of enterprise computing—in particular enterprise computing enjoying a social networking aspect such as group calendaring and scheduling (C&S) or more advanced collaborative computing environments. In enterprise computing, an activity stream ordinarily includes events produced by different contacts of the end user, and event produced by others in connection with different contacts of the end user. For a small enterprise computing system, therefore, the event stream can include all such events as the number of events to be incorporated at any one time in an activity stream is small. However, for a large enterprise computing system, the number of events to be included in an activity stream can be overwhelming large.

Due to the possibility that an activity stream of an end user can become overrun with many contemporaneously occurring events, activity streams often employ filtering methods to limit the number of events to be included within an activity stream. For example, it is well-known to filter or at least sort events in an activity stream based upon the identity or role of a collaborator associated with each event, based upon a source of each event, based upon keywords in the event, or based upon tags affixed to the content. However, filtering events on such rudimentary grounds ignores the potential circumstance where an event in an activity stream requires the end user to perform an action in response to the event. To the extent that an event is filtered from view that requires an action on behalf of the end user, the end user will not know to perform such an action.

Further, to the extent that the event is not filtered from view, but joined by many other events also requiring an action on the part of the end user, the end user will not know which action to prioritize in respect to other actions required by the events. Thus, the activity stream though intended to create greater organization efficiencies on behalf of the end user actually can create a degree of chaos and inefficiency due to the ad hoc presentation of events requiring actions by the end user irrespective of the time required to perform such actions and the amount of time available for the end user to perform such actions.

### BRIEF SUMMARY OF THE INVENTION

Embodiments of the present invention address deficiencies of the art in respect to activity list management and provide a novel and non-obvious method, system and computer program product for time based activity list management. In an embodiment of the invention, a method for time based activity list management includes receiving a multiplicity of events in memory of a host computing system from over a computer communications network for display in an activity stream of an end user of an enterprise application executing in the memory of the host computing system. The method additionally includes selecting a subset of the events according to an action required to be performed by the end user by each of the events in the subset and prioritizing ones of the events with corresponding actions determined to require a greater period of time to complete. Finally, the method includes displaying the events in the activity stream in an order of priority determined for the events.

Optionally, an amount of time available to perform actions by the end user can be determined. Thereafter, a collection can be selected of events amongst the subset with actions requiring a total amount of time to complete that is less than the determined amount of time available to perform the actions by the end user. As such, the collection of events can be displayed with a highest priority in the activity stream.

In one aspect of the embodiment, the subset of events is determined according to a presence in each event, or in a metadata description of the event, of one or more keywords known to require an action. In another aspect of the embodiment, an action is determined to require a greater period of time to complete based upon past statistics collected in respect to a time actually consumed to complete the action. In yet another aspect of the embodiment, an action is determined to require a lesser period of time to complete based upon an inferred familiarity by the end user with respect to an object associated with the action. In even yet another aspect of the embodiment, an action is determined to require a lesser period of time to complete based upon an inferred familiarity by the end with respect to subject matter stated as part of the action.

In another embodiment of the invention, an enterprise data processing system is configured for time based activity list management. The system includes a host computing system that includes at least one computer with memory and at least one processor. The system also includes an enterprise application executing in the host computing system and providing an activity stream for an end user of the enterprise application. Finally, the system includes a time based activity list management module coupled to the enterprise application. The module includes program code enabled upon execution in the memory of the host computing system to select a subset of events received in the activity stream according to an action required to by performed by the end user by each of the events in the subset, to prioritize ones of the events with corresponding actions determined to require a greater period of time to complete, and to display the events in the activity stream in an order of priority determined for the events.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for time based activity list management;

FIG. 2 is a schematic illustration of an enterprise data processing system configured for time based activity list management; and,

FIG. 3 is a flow chart illustrating a process for time based activity list management.

### DETAILED DESCRIPTION OF THE INVENTION

Embodiments of the invention provide for time based activity list management. In accordance with an embodiment of the invention, different events can be received by an end user in an activity stream of an enterprise data processing system. A subset of the events requiring an action by the end user can be selected, and a time value to complete each action computed for each event in the subset. Thereafter, a priority can be assigned to each of the events of the activity stream, with a higher priority assigned to events of the subset. Further, an even higher priority can be assigned to events of the subset with larger time values indicating a longer period of time necessary to perform the action. Finally, the events of the activity stream can be filtered so as to maximize a number of highest priority events able to be completed within a determined period of time.

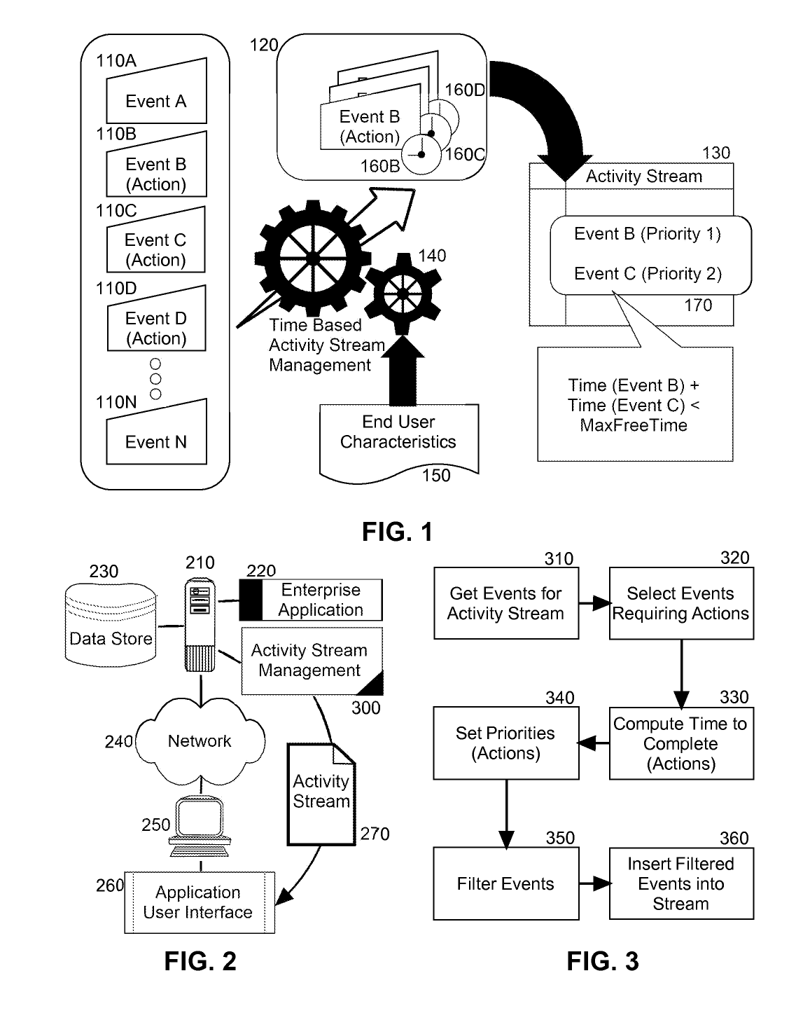

In further illustration, FIG. 1 is a pictorial illustration of a process for time based activity list management. As shown in FIG. 1, a series of events 110A . . . 110N can be received for inclusion in an activity stream 130. Time based activity stream management logic 140 can process the events 110A . . . 110N to identify a subset 120 including those of the events 110A . . . 110N that require an action on the part of the end user. For example, the text of the events 110A . . . 110N can be parsed to identify keywords known to indicate the requirement of an action such as “approval”, “comment”, “read”, “review”, “revise”, “schedule”, “share”, “need” etc.

Of import, a time required 160B, 160C, 160D to complete each action of a corresponding one of the events 110A . . . 110N can be computed. In this regard, the time based activity stream management logic 140 can consult end user characteristics 150 in order to compute the time required 160B, 160C, 160D. Examples of the end user characteristics include past statistics collected in respect to a time actually consumed to complete the action, an inferred familiarity by the end user with respect to an object associated with the action or an inferred familiarity by the end with respect to subject matter stated as part of the action. With respect to the inferred familiarity by the end user with respect to an object associated with the action, to the extent the object is a document, it can be determined whether or not the end user had previously accessed the document so as to indicate some past familiarity with the document. Likewise, with respect to the inferred familiarity by the end user with respect to the subject matter stated as part of the action, it can be determined from a profile of the end user whether or not the user has a stated expertise corresponding to the subject matter. Such stated expertise can include a past work experience, past education, a reading history, or a social networking rank or achievement to name a few examples.

The time based activity stream management logic 140 can process the computed time required 160B, 160C, 160D for the actions in order to determine a number of the corresponding events for the actions able to be performed by the end user within a specified period of time. For example, the specified period of time can include the known free time for the end user based upon a review of the calendared meetings and tasks assigned to the end user. Alternatively, the specified period of time can include a pre-determined value. In any event, the events 110B, 110C, 110D with corresponding actions can be filtered to a collection 170 to include only those of the events 110B, 110C, 110D with corresponding computed times 160B, 160C, 160D that sum to less than the specified period of time. Thereafter, the collection 170 is displayed in the activity stream 130.

The process described in connection with FIG. 1 can be implemented in an enterprise data processing system. In yet further illustration, FIG. 2 schematically shows an enterprise data processing system configured for time based activity list management. The system includes a host computing system 210 that may include one or more computers, each with memory and at least one processor. The host computing system 210 can support the operation of an enterprise application 220 accessing data in a data store 230. An application user interface 260 provided in a client computer 250 can access the data in the data store 230 through the enterprise application 220 over computer communications network 240. Of import, an activity stream 270 can be presented in the application user interface by an activity stream management module 300.

Notably, the activity stream management module 300 can include program code that when executed in the memory of the host computing system 210 is enabled to select a subset of events received in the activity stream 270 according to an action required to by performed by an end user of the enterprise application 220 by each of the events in the subset, to prioritize ones of the events with corresponding actions determined to require a greater period of time to complete, and to display the events in the activity stream 270 in an order of priority determined for the events. Optionally, the program code of the activity stream management module 300 can be enabled to determine an amount of time available to perform actions by the end user, to select from amongst the subset, a collection of events with actions requiring a total amount of time to complete that is less than the determined amount of time available to perform the actions by the end user and to display with a highest priority in the activity stream 270 the collection of events.

In even yet further illustration of the operation of the activity stream management module 300, FIG. 3 is a flow chart illustrating a process for time based activity list management. Beginning in block 310, a multiplicity of events can be received for presentation in an activity stream of an end user. In block 320, a subset of the events can be determined to include events that each require a responsive action on the part of the end user. In block 330, a time necessary to complete each of the actions can be determined. Thereafter, in block 340 each of the events can be prioritized based upon the time necessary to complete a corresponding action. In particular, events for which actions require more time to complete can receive a higher priority. Subsequently, in block 350 the events can be filtered to include only a collection of the highest priority events. Optionally, a collection of events with actions requiring a total required time to complete that is less than an specified amount of time for the end user can be included in a collection of events and displayed in the activity stream in block 360.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for time based activity list management, the method comprising:
receiving a multiplicity of events in memory of a host computing system from over a computer communications network for display in an activity stream of an end user of an enterprise application executing in the memory of the host computing system;
selecting a subset of the events according to an action required to be performed by the end user by each of the events in the subset;
prioritizing ones of the events with corresponding actions determined to require a greater period of time to complete; and,
displaying the events in the activity stream in an order of priority determined for the events.

2. The method of claim 1, wherein the subset of events is determined according to a presence in each event or in metadata for each event of one or more keywords known to require an action.

3. The method of claim 1, wherein an action is determined to require a greater period of time to complete based upon past statistics collected in respect to a time actually consumed to complete the action.

4. The method of claim 1, wherein an action is determined to require a lesser period of time to complete based upon an inferred familiarity by the end user with respect to an object associated with the action.

5. The method of claim 1, wherein an action is determined to require a lesser period of time to complete based upon an inferred familiarity by the end user with respect to subject matter stated as part of the action.

6. The method of claim 1, further comprising:
determining an amount of time available to perform actions by the end user;
selecting from amongst the subset, a collection of events with actions requiring a total amount of time to complete that is less than the determined amount of time available to perform the actions by the end user; and,
displaying with a highest priority in the activity stream the collection of events.

7. An enterprise data processing system configured for time based activity list management, the system comprising:
a host computing system comprising at least one computer with memory and at least one processor;
an enterprise application executing in the host computing system and providing an activity stream for an end user of the enterprise application; and,
a time based activity list management module coupled to the enterprise application, the module comprising program code enabled upon execution in the memory of the host computing system to select a subset of events received in the activity stream according to an action required to by performed by the end user by each of the events in the subset, to prioritize ones of the events with corresponding actions determined to require a greater period of time to complete, and to display the events in the activity stream in an order of priority determined for the events.

8. The system of claim 7, wherein the subset of events is determined according to a presence in each event or in metadata for each event of one or more keywords known to require an action.

9. The system of claim 7, wherein an action is determined to require a greater period of time to complete based upon past statistics collected in respect to a time actually consumed to complete the action.

10. The system of claim 7, wherein an action is determined to require a lesser period of time to complete based upon an inferred familiarity by the end user with respect to an object associated with the action.

11. The system of claim 7, wherein an action is determined to require a lesser period of time to complete based upon an inferred familiarity by the end with respect to subject matter stated as part of the action.

12. The system of claim 7, wherein the program code is further enabled upon execution in the memory of the host computing system to determine an amount of time available to perform actions by the end user, to select from amongst the subset, a collection of events with actions requiring a total amount of time to complete that is less than the determined amount of time available to perform the actions by the end user and to display with a highest priority in the activity stream the collection of events.

13. A computer program product for time based activity list management, the computer program product comprising a computer readable storage medium having program instructions embodied therewith, the program instructions executable by a device to cause the device to perform a method comprising:
receiving a multiplicity of events in memory of a host computing system from over a computer communications network for display in an activity stream of an end user of an enterprise application executing in the memory of the host computing system;
selecting a subset of the events according to an action required to by performed by the end user by each of the events in the subset;
prioritizing ones of the events with corresponding actions determined to require a greater period of time to complete; and,
displaying the events in the activity stream in an order of priority determined for the events.

14. The computer program product of claim 13, wherein the subset of events is determined according to a presence in each event or in metadata for each event of one or more keywords known to require an action.

15. The computer program product of claim 13, wherein an action is determined to require a greater period of time to complete based upon past statistics collected in respect to a time actually consumed to complete the action.

16. The computer program product of claim 13, wherein an action is determined to require a lesser period of time to complete based upon an inferred familiarity by the end user with respect to an object associated with the action.

17. The computer program product of claim 13, wherein an action is determined to require a lesser period of time to complete based upon an inferred familiarity by the end user with respect to subject matter stated as part of the action.

18. The computer program product of claim 13, further comprising:
determining an amount of time available to perform actions by the end user;
selecting from amongst the subset, a collection of events with actions requiring a total amount of time to complete that is less than the determined amount of time available to perform the actions by the end user; and,
displaying with a highest priority in the activity stream the collection of events.
